(19) United States
(12) Patent Application Publication
(10) Pub. No.: US 2022/0188624 A1
(43) Pub. Date: Jun. 16, 2022

(54) System and Method for Monitoring Driver Performance

(71) Applicant: Bendix Commercial Vehicle Systems, LLC, Elyria, OH (US)

(72) Inventors: Andreas U. KUEHNLE, Elyria, OH (US); Shaun M. HOWARD, Elyria, OH (US); Hans M. MOLIN, Elyria, OH (US); Todd YOSHIKAWA, Elyria, OH (US); Andre TOKMAN, Elyria, OH (US)

(21) Appl. No.: 17/118,458

(22) Filed: Dec. 10, 2020

(51) Int. Cl. G06N 3/08; G06F 11/34; G06F 11/30; G06N 5/02

(52) U.S. Cl. CPC G06N 3/08; G06N 5/02; G06F 11/3013; G06F 11/3438

(57) ABSTRACT

A system for monitoring driver performance includes a server system that generates a performance model based on driver performance related data received from a plurality of vehicles. The performance model mathematically characterizes the crowd wisdom for a driving behavior under a set of driving circumstances. The system also includes the plurality of vehicles, each having an on-vehicle system that compares driver performance related data characterizing the driving behavior performed by the driver of the vehicle under the set of driving circumstances to the performance model so as to determine a deviation score therebetween. The deviation scores for the driving behavior are accumulated over a predetermined period of time, and a divergence indicator is triggered in response to an accumulated deviation score value exceeding one or more predetermined thresholds.

### FIELD OF THE INVENTION

The invention relates to improvements in monitoring driver performance, and in particular to monitoring driver performance based on deviations from the crowd wisdom.

### BACKGROUND

Current methods of monitoring driver performance involve checking driver and/or vehicle behavior data against predefined behavior models for undesired behaviors. In other words, these systems look for undesired behavior. For example, there may be a preset following distance threshold, the violation of which by the driver triggers the driver performance as undesired. As another example, the driver's posture or facial features may be monitored via an in-cabin camera and compared to a preset model for what drowsiness or fatigue or distraction looks like.

A problem with these approaches is that they require that the undesired behavior be defined by the model before it can be looked for. This is problematic because such undesired behavior may look different from driver to driver and depending on the driving circumstances. The set of undesired behavior to be looked for is also necessarily limited to what can be predefined.

As such, there is a need in the art for a system and method that overcomes the aforementioned drawbacks.

### SUMMARY OF THE INVENTION

Systems and methods for driver performance monitoring are disclosed, in which real-time driver behavior is compared to a crowd wisdom based performance model for that driver behavior, and statistically significant differences are aggregated over time to indicate undesired driving performance. The systems and methods recognize that crowd wisdom can be utilized to statistically identify safe driver behavior, and that prolonged or sharp statistically significant deviations from the crowd wisdom over periods of time indicate undesired driver behavior, such as driver fatigue, distraction or impairment.

In at least one embodiment, a system for monitoring driver performance includes a server system that generates a performance model based on driver performance related data received from a plurality of vehicles. The performance model mathematically characterizes the crowd wisdom for a driving behavior under a set of driving circumstances. The system also includes the plurality of vehicles, each having an on-vehicle system. Each on-vehicle system is configured to generate driver performance related data characterizing the driving behavior performed by the driver of the vehicle under the set of driving circumstances. Each on-vehicle system is further configured to determine a z-score between the generated driver performance related data and the performance model, for the driving behavior under the set of circumstances. Each on-vehicle system is still further configured to accumulate determined z-scores for the driving behavior over a predetermined period of time. Each on-vehicle system is still further configured to generate a divergence indicator in response to the accumulated z-scores exceeding one or more predetermined thresholds, and to control one or more vehicle systems, based on the divergence indicator.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an exemplary system for driver performance monitoring, in accordance with one or more aspects of the invention;

FIG. 2 is a block diagram that illustrates a vehicle-based computer system configured to implement one or more aspects of the invention, in accordance with one or more aspects of the invention;

FIG. 3 is an exemplary statistical distribution characterizing historical driver behavior across the plurality of vehicles of the system, in accordance with one or more aspects of the invention;

FIG. 4 is a schematic illustration of an exemplary system architecture, in accordance with one or more aspects of the invention;

FIG. 5 is a set of exemplary statistical distributions characterizing historical driver behavior across the plurality of vehicles of the system

FIG. 6 is flow-chart illustrating an exemplary method, in accordance with one or more aspects of the invention.

### DESCRIPTION OF EXEMPLARY EMBODIMENTS OF THE INVENTION

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

Further in accordance with the practices of persons skilled in the art, aspects of one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

In accordance with the descriptions herein, the term “computer readable medium,” as used herein, refers to any non-transitory media that participates in providing instructions to the processor for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like.

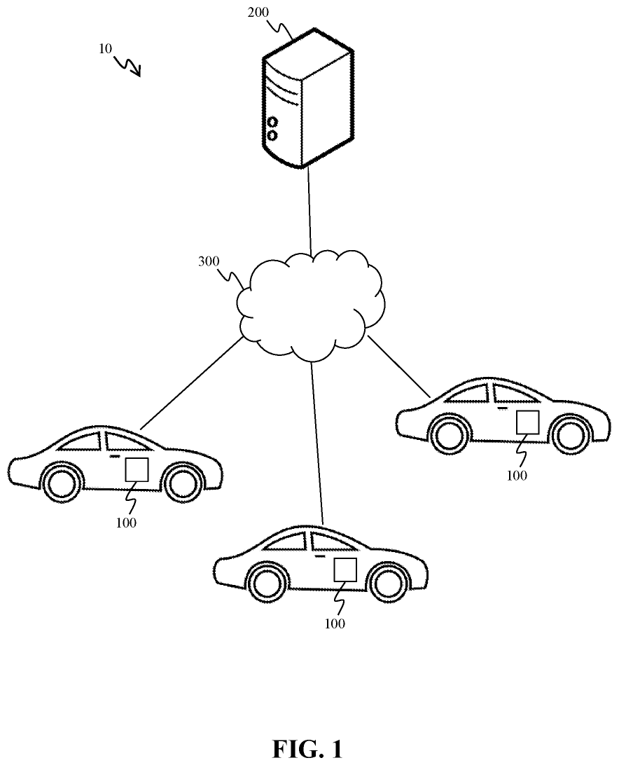

In addition, and further in accordance with the descriptions herein, the term “logic,” as used herein, particularly with respect to FIG. 1, includes hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components.

The invention relates generally to a driver performance monitoring system that determines undesired driving performance based on crowd wisdom determined driver behavior. In particular, the system monitors for an accumulation of statistically significant deviations from the crowd wisdom determined driver behavior, rather than directly monitoring for predefined undesired driver behaviors. Accordingly, more passive conditions such as driver fatigue or distraction—which are difficult to determine directly—can be identified more readily and reliably.

FIG. 1 shows a schematic illustration of the driver performance monitoring system 10 in accordance with at least one embodiment. The driver performance monitoring system 10 includes a plurality of vehicles, each equipped with an on-board system 100 configured to capture driver performance related data corresponding to detected driver and/or vehicle related parameters during a driving excursion. The driver and/or vehicle related parameters may reflect operational parameters and/or conditions of the vehicle and/or the driver's interaction therewith, which characterize driving circumstances (e.g., daytime/nighttime, weather conditions, vehicle speed, vehicle maintenance status, etc.) and/or driver behavior (e.g., gas/brake pedal pressure, turn signal usage, head movement, distance from front vehicle the driver keeps) under the driving circumstances. For instance, the driving circumstances may include parameters such as: daytime/nighttime, weather conditions, vehicle speed, vehicle maintenance status, local road curvature, recent traffic sign/signal information, lane markings, etc., whereas the driver behavior may include parameters such as: gas/brake pedal pressure, turn signal usage, head movement, distance from front vehicle, lane position, etc. In some cases, certain parameters, such as vehicle speed, for instance, may characterize both driving circumstances and driver behavior.

The driver performance monitoring system 10 further includes a server system 200 communicatively coupled to the on-board system 100 via a network 300. The network 300 is preferably a wireless network configured to facilitate the communication and transmission of data, instructions, etc. from one component to another component of the network. For example, the network 300 may be a cellular network, the Internet, or any other type of network, or combination thereof. The server system 200 many include one or more server computers connected to the network 300. Each server computer may include computer components, including one or more processors, memories, displays and interfaces, and may also include software instructions and data for executing the functions of the server system described herein.

Each of the on-board systems 100 is configured to transmit the respective driver performance related data, via the network 300, to the server system 200, which is adapted to process historical driver performance related data received from the plurality of vehicles so as to generate one or more performance models that reflect the crowd wisdom of the drivers of the plurality of vehicles. The crowd wisdom characterizes the driver behavior of the plurality of vehicles under various driving circumstances. In other words, the crowd wisdom is an organic measure of how drivers drive under various circumstances. Under the assumption that the drivers tend towards behaviors that are reasonable or otherwise safe under the circumstances, each performance model is defined by a central value reflecting driver behaviors that, according to the crowd wisdom, are safe driver behaviors under the driving circumstances. In at least some embodiments, the server system 200 includes one or more neural networks trained with historical driver performance data to determine the performance models.

The server system 200 is also configured to transmit the performance model to the on-board system 100, which may be further configured to compare current collected driver performance data to the performance model to determine statistically significant deviations, e.g., z-scores, from the one or more characteristic values. It will be understood that, while z-scores are referenced herein to illustrate the principles of the invention, the statistically significant deviations may be determined as median absolute deviations, or by any other statistical methodology. The on-board system 100 may track the accumulation of z-scores over a period of time, and may generate a divergence indicator where the accumulated z-scores exceed a predetermined threshold. For instance, the aggregated z-scores indicate a prolonged and/or substantial deviation from the determined crowd wisdom, which may suggest driver distraction, fatigue and/or other undesirable driver performance.

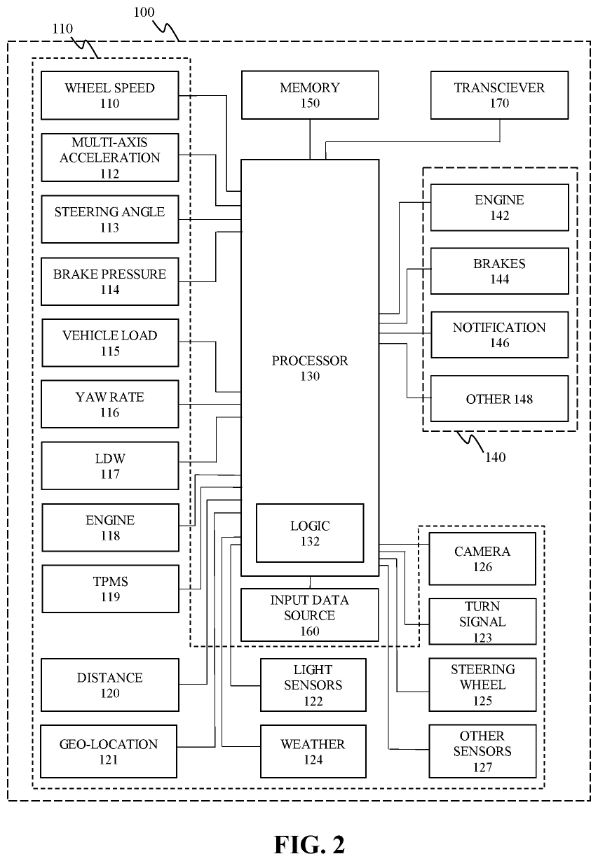

Referring now to FIG. 2, a schematic block diagram illustrates details of the on-board system 100 in accordance with one or more embodiments. The on-board system 100 may be adapted to detect driver performance related data and, based thereon, to determine whether accumulated deviations of the driver's performance from the crowd wisdom based performance model indicates undesirable driver performance. The driver performance related data and/or a divergence indicator may be stored and/or transmitted to the server system 200, as described in more detail below.

The on-board system 100 may include one or more devices and/or systems 110 for providing input data indicative of the one or more operational parameters and/or conditions of the vehicle. For example, the devices 110 may be one or more sensors, such as but not limited to, one or more wheel speed sensors 111, one or more acceleration sensors such as multi-axis acceleration sensors 112, a steering angle sensor 113, a brake pressure sensor 114, one or more vehicle load sensors 115, a yaw rate sensor 116, a lane departure warning (LDW) sensor or system 117, one or more engine speed or condition sensors 118, and a tire pressure (TPMS) monitoring system 119. The on-board system 1000 may also utilize additional devices or sensors, including for example one or more forward, rear or side distance sensors 120 (e.g., radar, lidar, etc.), geo-location sensors 121 (e.g., GPS), light sensors 122, turn signal sensors 123, weather sensors 124 (e.g., temperature, humidity, etc.), steering wheel sensors 125 (i.e., angle, haptic pressure, etc.), and cameras 126 (driver facing, outward facing, etc.). Other sensors 127 and/or actuators or power generation devices or combinations thereof may be used of otherwise provided as well, and one or more devices or sensors may be combined into a single unit as may be necessary and/or desired. One or more of the devices and/or systems 110 may be configured separate from the on-board system 100, which may also include a signal interface for receiving signals from one or more of the devices and/or systems 110 so separately configured.

The on-board system 100 may further include a logic applying arrangement such as a controller or processor 130 and control logic 132, in communication with the one or more devices or systems 110. The processor 130 may instruct the respective components to perform various tasks based on the processing of information and/or data, such as software instructions and/or stored data. The processor 130 may be a standard processor, such as a central processing unit (CPU), or may be dedicated processor, such as an application-specific integrated circuit (ASIC) or a field programmable gate array (FPGA), or a graphical processing unit (GPU). The processor 130 may further include one or more inputs for receiving input data from the devices or systems.

The processor 130 may be adapted to process the input data, so as to generate the driver performance related data, and to store the driver performance related data in the memory 150 for transmission to the server system 200, or other use. The processor 130 may be further adapted to compare the driver performance data to the performance model received from the server system, so as to determine statistically significant deviations, e.g. z-scores, from the one or more characteristic values. The processor 130 may be further adapted to determine that the current driver performance is diverges unacceptably from the crowd wisdom based on accumulated deviations, e.g., z-scores, exceeding one or more predetermined thresholds, and to generate a divergence indicator indicating such divergence from the crowd wisdom.

The processor 130 may also include one or more outputs for delivering a control signal to one or more vehicle systems 140 based on the divergence indicator. The control signal may instruct the systems 140 to provide one or more types of driver assistance warnings (e.g., warnings relating to braking and or obstacle avoidance events) and/or to intervene in the operation of the vehicle to initiate corrective action. For example, the processor 130 may generate and send the control signal to an engine electronic control unit or an actuating device to reduce the engine throttle 142 and slow the vehicle down. Further, the processor 130 may send the control signal to one or more vehicle brake systems 144 to selectively engage the brakes (e.g., a differential braking operation). A variety of corrective actions may be possible and multiple corrective actions may be initiated at the same time via these and other vehicle systems 148.

The on-board system 100 may still further include one or more notification devices 146, which may be usable to provide notifications to the driver, as well as to other drivers around the vehicle. For instance, the notification devices 146 may include brake lights, hazard lights, turn signals, etc. that may be activated to provide headway time/safe following distance warnings, lane departure warnings, warnings relating to braking, etc., as well as speakers, dashboard lights, heads-up-display indicators, steering wheel vibrators, etc., that may be activated to provide audio, visual and/or haptic warnings to the driver.

The on-board system 100 may also include a memory 150 for storing and accessing system information, such as for example the system control logic and/or data. For example, the memory 150 may be random access memory (RAM) or other dynamic storage device for storing instructions and loaded portions of a trained neural network to be executed by the processor, and read only memory (ROM) or other static storage device for storing other static information and instructions for the processor. Other storage devices may also suitably be provided for storing information and instructions as necessary or desired. The memory 150 may be separate from the processor 130, and the sensors 110 and processor 130 may be part of a preexisting system or use components of a preexisting system. The data can be any data that can be retrieved, manipulated and/or stored by the processor 130 in accordance with the control logic 132 or other sets of executable instructions.

The on-board system 100 may also include a source of vehicle-related input data 160 indicative of a configuration or condition of the vehicle. The processor 130 may sense or estimate the configuration or condition of the vehicle based on the input data, and may select a control tuning mode or sensitivity based on the vehicle configuration or condition. The processor 130 may compare the operational data received from the sensors or systems 110 to the information provided by the tuning, so as to, for instance, more accurately detect the driver performance related data.

Still further, the on-board system 100 may also include a transmitter/receiver (transceiver) module 170 such as, for example, a radio frequency (RF) transmitter including one or more antennas for wireless communication of driver performance related data, and other data and signals, to the server system. The transmitter/receiver (transceiver) module 170 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 130 may be operative to combine selected ones of the collected signals from the sensor systems 110 described herein into processed data representative of higher-level vehicle conditions and/or operational parameters, which reflect driver performance data. For example, data from the multi-axis acceleration sensors 112 may be combined with the data from the steering angle sensor 113 or camera 126 to determine curve speed data. Other hybrid driver performance data relatable to the vehicle and driver of the vehicle and obtainable from combining one or more selected raw data items from the sensors 110 includes, for example and without limitation, braking data, curve speed data, lane departure data, lane change data, following distance event data, and speed adaptation data.

The on-board monitoring system 100 is suitable for executing embodiments of one or more software systems or modules that perform driver monitoring, notification and intervention according to the subject application. The on-board monitoring system 100 may further include a bus 402 or other communication mechanism for communicating information among the various components. Accordingly, instructions may be read into the memory 150 from another computer-readable medium, such as another storage device of via the transceiver. Execution of the sequences of instructions contained in main memory 150 causes the processor 130 to perform the process steps described herein. In an alternative implementation, hard-wired circuitry may be used in place of or in combination with software instructions to implement the invention. Thus, implementations of the example embodiments are not limited to any specific combination of hardware circuitry and software.

Returning now to FIG. 1, an aspect of the driver behavior and monitoring system 10 is that crowd wisdom provides central values that identify reasonably safe (or otherwise acceptable) driver behavior under various driving circumstances. In other words, most drivers tend to behave in some accepted common way under similar driving circumstances. Drivers indeed rarely behave in ways they believe are unusual or otherwise inappropriate.

As a simple example, most drivers naturally keep certain following distance from the preceding vehicle. That following distance also naturally varies as a function of the current vehicle speed: the following distance tends to be greater at greater speeds. This common safe behavior—with respect to following distance or some other metric—can be identified empirically through statistical analysis of collected driver behavior related data.

Accordingly, in at least one embodiment, the server system 200 is configured to implement a mass data collection of the historical driver performance related data from the on-board systems 100 of the plurality of vehicles. As discussed above, the driver performance related data reflects driver and/or vehicle parameters that characterize driver behavior and driving circumstances. The gathered driver performance data is such that the server system can, as discussed herein, determine an empirical coupling between measured driving circumstances and driver behavior. In other words, under F(x, y, z) driving circumstances, where x, y and z reflect driving circumstance parameters (e.g., vehicle speed, daylight, etc.), the driving behavior of driver A is G(j, k), where j and k reflect driving behavior parameters (e.g., following distance, etc.).

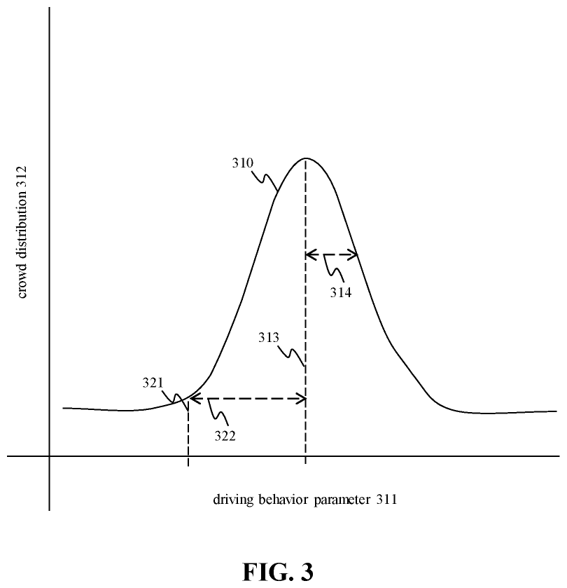

The server system 200 is further configured to processes the collected driver performance related data so as to generate the one or more performance models. Each of the performance models corresponds to a statistical distribution 310 characterizing historical driver behavior under given driving circumstances and across the plurality of vehicles of the system 10. An exemplary such statistical distribution is shown in FIG. 3 as a Gaussian distribution.

In the example of following distance as a function of vehicle speed, FIG. 3 would reflect the statistical distribution of following distances for a given vehicle speed, or range thereof. The x-axis would represent the different values for the behavior parameters 311 being monitored, e.g., following distances, or ranges thereof, collected across the plurality of vehicles over time, whereas the y-axis would represent the frequency at which those values occurred within the system, i.e., the crowd distribution 312. The central value 313 of the distribution in FIG. 3 would therefore reflect the crowd wisdom for what a safe following distance would be for the given vehicle speed. The dispersion 314, e.g. the standard deviation, would therefore reflect the statistical variation for that safe following distance. The central value 313 and dispersion 314 thus reflect an empirically determined crowd wisdom for the range of safe driver behavior with respect to following distance at the given vehicle speed. It will be further understood that the distributions may also be multi-dimensional. For example, the following distance may be a function of the vehicle speed and the relative speed to a target ahead. The dispersion measure is then generalized with respect to the multi-dimensional scenario. For example, the dispersion measure can be generalized to the trace or determinant of a covariance matrix.

The system server 200 may be configured to process the driver performance related data according to a statistical binning procedure, so as to determine the crowd wisdom from the statistical distribution. One or more bins may be defined such that each bin defines the driving circumstances under consideration. That is, each bin may be defined by a parameter value for each of one or more associated driver and/or vehicle related parameters characterizing the driving circumstances. Referring again to the prior example, a plurality of bins may be defined according to various vehicle speed ranges, e.g., 10-20 mph, 20-30 mph, etc., where the vehicle speed is the parameter characterizing the driving circumstances. It will be understood, however, that the bins may be defined by alternative and/or additional driver and/or vehicle parameters.

The driver performance related data characterizing the historical driver behavior across the plurality of vehicles of the system 10 may accordingly be assigned to the appropriate bin. That is, parameter values for each of one or more associated driver and/or vehicle related parameters characterizing the driver behavior of interest are assigned to their appropriate bins. Referring again to the prior example, the various historical following distances would be associated with the appropriate vehicle speed bins, e.g., 10-20 mph, 20-30 mph, etc., according to the following distances that occurred at those speeds.

The one or more bins may comprise look-up tables correlating the data. As the amount of binned driver behavior data reaches statistical significance, the statistical distribution achieves a distribution shape, such as the bell curve shown in FIG. 3, from which the central value and the dispersion can be determined by the server system. Other distribution shapes are of course possible, such as, for example, Gaussian and log-normal distributions. In this manner, the server system may process the driver performance related data to generate the statistical distributions reflecting the performance models.

While the aforementioned example described performance models for following distance as a function of vehicle speed, the server system 200 may be configured to apply the described principles to generate performance models for any of a number of possible driver behaviors under any of a number of possible driving circumstances. For instance, possible target driver behaviors include but are not limited to: lane keeping, lane changing and gear shifting, each of which may be defined by one or more driver and/or vehicle related parameters, whereas additional driving circumstances may include but are not limited to: weather conditions, road slope or curvature, and time of day, each of which may be defined by one or more of their own driver and/or vehicle related parameters. Expanding on the prior example, for instance, the binning can be according to each of the aforementioned parameters characterizing driving circumstances, such that there could be a bin for following distances occurring when the vehicle speed was between 20-30 mph on a straight road section between 6:00 and 9:00 PM during a light rain. In some embodiments, interpolation methods, e.g., via neural networks or other methodologies, may be utilized to fill in gaps in the gathered data.

It will be understood, however, that where the driving circumstances are too narrowly defined, and therefore too specific, the ready collection of driver performance data reflecting driver behavior under such driving circumstances becomes problematic. On the other hand, where the driving circumstances are too broadly defined, the dispersion of the resulting statistical distribution is rendered too large to meaningfully reflect the crowd wisdom. An optimization of the driving circumstances may therefore be performed to determine the optimal driving circumstances reflecting parameters for consideration in generating the performance models. Principle component analysis may also be utilized to identify which such parameters are most useful in generating the performance model.

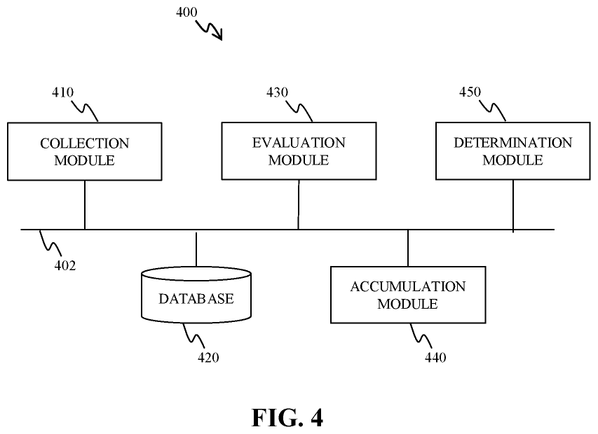

Turning now to FIG. 4 an exemplary architecture 400 of the on-board system 100 via which the control logic 132 and/or processor 130 implements aspects of one or more embodiments. The exemplary architecture 400 comprises a collection module 410, a database 420, an evaluation module 430, an accumulation module 440, and a determination module 450.

The collection module 410 collects and processes the input data received from the various devices, so as to generate the driver performance related data, which is stored in the database 420 for transmission to the server system 200 or use by the evaluation module 430.

The evaluation module 430 compares the driver performance related data to the one or more performance models, which may also be stored in the database 420, so as to determine statistically significant deviations from the one or more performance models. In particular, the evaluation module 430 determines a median absolute deviation, e.g., a z-score, for the current driver behavior, as characterized by one or more associated driver and/or vehicle related parameters, with respect to the performance model reflecting the crowd wisdom based driver behavior under the same or similar driving circumstances. The median absolute deviation, e.g., z-score, reflects the number of standard deviations by which the current driver behavior is different from the central value, and is used to normalize and measure the deviations of current driver behavior from the central value. Smaller median absolute deviations reflect minor deviations from the crowd wisdom, whereas larger median absolute deviations reflect significant departures from the crowd wisdom. The evaluation unit may determine median absolute deviations on a continuous, semi-continuous, periodic, or on-demand basis.

Referring again to FIG. 3 and the prior example of following distance as a function of vehicle speed, the parameter characterizing the current driver behavior 321 would be the following distance, whereas the driving circumstances would be the vehicle speed. The evaluation unit would therefore compare the current following distance at the current speed (or speed range) to the corresponding performance model for that speed (or speed range), so as to identify and quantify (in terms of a z-score) any deviations 322. The comparison might show that, for example, the current measured value for following distance is below the central value by 2.5 dispersions, i.e., that it has a z-score of −2.5, indicating that the following distance is too small.

Again, the example of following distance as a function of vehicle speed is merely illustrative, and the principles described herein can be applied to other driver behaviors under other driving circumstances. The principles described herein may also be applied to evaluating a plurality of driver behaviors for deviations from respective performance models.

The accumulation module 440 maintains a running accumulation, or sum total, of calculated median absolute deviations, e.g. z-scores, for each considered driver behavior over a period of time. The time periods over which the median absolute deviations are accumulated may be settable according to the driver behavior of interest, or any other consideration. For example, the accumulation module 440 can sum median absolute deviations for following distance over the past 5 minutes, whereas the accumulated median absolute deviation for lane keeping are only over the past 3 minutes. The time-scale may be selected to detect divergences over shorter or longer terms. In particular, a long-term accumulation of median absolute deviations may be utilized to detect fatigue, whereas a short-term accumulation of median absolute deviations may be utilized to detect distraction or impeded performance.

Because the median absolute deviations can be positive or negative, alternating deviations from the central value—characteristic of the crowd wisdom target behavior—tend to cancel each other out, trending the accumulated median absolute deviation value towards zero—whereas consistent deviations in either direction tend to build over time, trending the accumulated median absolute deviation value away from zero. The driver behavior may be identified as less safe or otherwise undesirable when the accumulated median absolute deviation value exceeds a deviation threshold.

The determination module 450 identifies the driver behavior as differing sufficiently and/or persistently from the norm—and therefore as less safe or otherwise undesirable—when the accumulated median absolute deviation value associated with the driver behavior exceeds the deviation threshold. Such exceeding of the deviation threshold may, for instance, occur as a result of a persistent divergence from the crowd wisdom and/or as a result of an extreme divergence from the crowd wisdom. For instance, referring to the prior example, persistently following too closely over a longer interval may cause the accumulated median absolute deviation value for following distance to exceed the deviation threshold. On the other hand, the deviation threshold may also be exceeded by close tailgating over a shorter interval.

One or more deviation thresholds may be set for each driver behavior being monitored by the system. Where multiple deviation thresholds are set for a given driver behavior, those deviation thresholds may reflect different gradations of divergence.

The determination module 450 also generates the divergence indicator for the driver behavior in response to determining that the accumulated median absolute deviation value for the driver behavior exceeds one or more of the deviation thresholds. The divergence indicator can include information on type and/or severity of the deviations of the driver behavior from the crowd wisdom, which may be based on the specific behavior and/or the deviation thresholds exceeded.

The processor 130 may, in turn, deliver control signals to the one or more vehicle systems 140, based on the divergence indicator, which may instruct the vehicle systems to provide driver assistance warnings or notifications and/or to intervene in the operation of the vehicle to initiate corrective action. The type of warning or intervention may be based on the type and/or severity of the divergence indicator. For example, a somewhat short following distance may cause the processor 130 to output a warning to the driver (or other drivers) identifying the divergence from the crowd wisdom following distance, whereas extreme tailgating may prompt the processor 130 to intervene in the control of the vehicle to increase the following distance. The divergence indicator may also be transmitted to the server 200 for association with a driver profile, or stored in the memory for later retrieval. In some embodiments, a target driver may also be characterized by their typical deviation from the crowd, e.g. the typical following distance for the target driver is some standard deviation value closer than for the crowd. The server system may utilize the driver profile information automatically assign drivers for identified and/or anticipated driving circumstances, e.g., routes, traffic conditions, vehicle types, etc., so as to provide a “best fit” for such driving circumstances.

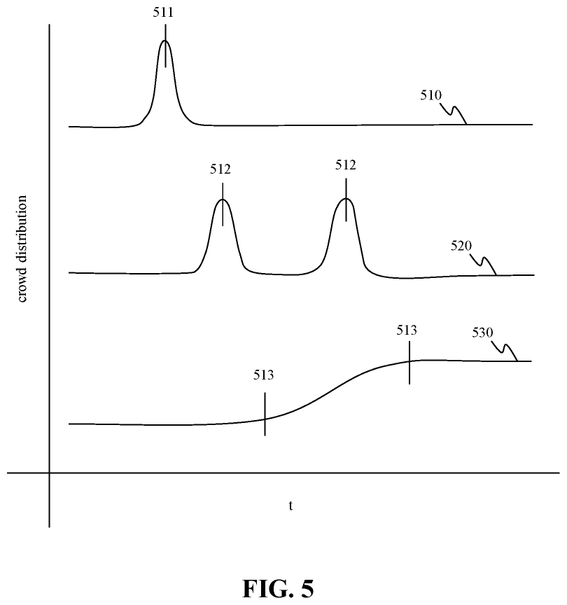

Turning now to FIG. 5, the prior example of following distance as a function of driver speed is an example of evaluating current driver performance without considering that driver behavior is often multi-variable and temporal. FIG. 5 illustrates exemplary statistical time distributions for driver head yaw 510, turn signal activation/deactivation 520, and lane position 530. Together, these parameters reflect the driver behavior of a lane change maneuver. The driver head yaw time distribution reflects the crowd wisdom for when, during the lane change maneuver, the driver head yaw should reach its maximum. The turn signal activation/deactivation time distribution reflects the crowd wisdom for when, during the lane change maneuver, the turn signal should be activated/deactivated. The lane position time distribution reflects the crowd wisdom for when, during the maneuver, the vehicle should initiate and complete the lane change. As can be seen, the crowd wisdom of FIG. 5 indicates that the lane change should be preceded by checking the side mirror and/or blind spot, activating the turn signal, then executing the lane change. These timings indicate the crowd wisdom, and the central values 511, 512, 513 and dispersions reflect the performance models for the lane change maneuver. It will be appreciated that the desirable behavior time-history may vary as a function of vehicle speed, or other driving circumstance(s), in accordance with the principles discussed herein. Moreover, the order in which the behaviors occur may also vary according to the crowd wisdom, which may also be reflected in a larger standard deviation.

The corresponding driver head yaw, turn signal activation/deactivation, and lane position timings may be compared to the lane change maneuver performance models to determine deviations from the crowd wisdom, as discussed above. In the multi-variable driver behavior case, the accumulated median absolute deviation, e.g., z-score, value may be a combined, e.g. by summing each component, value from each of the performance models relevant to the driver behavior. Thus, complex driver behaviors can be monitored and evaluated for consistency with the crowd wisdom.

It will be understood that, while aspects of the exemplary architecture 400 are discussed as being implemented via the on-board system, some or all of the exemplary architecture 400 may alternatively or additionally be implemented via the system server 200 without departing from the scope of the invention. Further aspects of the server system 200 will now be discussed.

In at least some embodiments, the server system 200 may be configured to generate the performance models via interpolation. For instance, the wisdom of the crowd vehicle acceleration may be described with a bin center at 25 mph and 100 ft to the vehicle ahead, with a bin size of +/−5 mph and +/−20 feet. That is to say that a first bin may be centered at (25+/−5 mph, 100+/−20 ft) and contain an acceleration distribution for those circumstances—whereas additional bins may be centered at (35+/−5 mph, 100+/−20 ft) and contain acceleration distributions for those circumstances. Off bin-center acceleration values may be interpolated between bins. For instance, the server system 200 may be configured to interpolate the acceleration central value and dispersion for 28 mph and 92 feet. Various interpolation methods, such as bilinear, may be used. Smoothing or curve fitting may also be applied to the collected driver performance data so as to derive the distribution parameters.

In further embodiments, the binned data may be used to train one or more neural networks to generate the one or more performance models using functional approximation and smooth interpolation techniques to model the crowd wisdom on a continuum. In particular, the neural networks may take as inputs the bin centers or the raw data, and may target as outputs the central value and the dispersion. For instance, the server system 200 may include two networks: one that determines the central values, and the other that determines the dispersions.

In still further embodiments, the server system 200 may be configured to prefilter the driver performance data so as to exclude some or all of the driver performance data from vehicles and/or drivers determined to be unreliable, and/or that may reflect detected safety events. Outlier removal may be applied to distributions that evince them. By prefiltering the driver performance data, the resulting crowd wisdom reflects more useful reference behavior that does not unnecessarily encompass the spectrum of all possible driver behavior.

Such prefiltering may filter out driver performance data from vehicles having diagnostic trouble codes that indicate the vehicle is unreliable, or indicate vehicle circumstances that the driver may be compensating for with their driving behavior. The prefiltering may further filter out driver performance data collected from drivers independently identified as generally undesired. The prefiltering may still further filter out driver performance data collected in proximity to a detected safety event, such as a collision or veering off the road. In some embodiments, some or all of the driver performance data corresponding to trips where safety events are detected may be prefiltered out. The prefiltering thus provides a data hygiene measure to ensure that the generated performance models reflect desired driver behavior.

In some cases, the prefiltering may only permit the crowd wisdom to be based on driver performance data reflecting the circumstances in which vehicles and drivers behave most normally or most desirably. As discussed herein, a presupposition is that the bulk and central value for any given circumstances tends towards safe, desirable behavior. For instance, the prefiltering can be based on region, time of day, or any other driving circumstances to reflect normal driving. The prefiltering may also more heavily weight the driver performance data of drivers whose profiles indicate exceedingly safe or desirable behavior, or other characteristics (e.g., age, experience, near well-known base location, etc.). Such weighting may be implemented by repeating measurements from the determined best drivers during creation of the crowd wisdom.

In some embodiments, an individualized adapted variation of comparing a driver with the wisdom of the crowd is possible. In operation, the driver may be characterized with respect to one or more crowd wisdom based performance models during an initial driving period. The initial driving period preferably corresponds to when the driver is presumably driving at their best, and may be, for example, the first 30 minutes to the first hour of driving. An average median absolute deviation, e.g., z-score, value specific to the driver may be determined during the initial driving period. For example, the driver's behavior may correspond to a percentile of the crowd behavior distribution, e.g., the 24^{th} percentile, that reflects the driver's typical deviation from the crowd wisdom.

One or more of the deviation thresholds may accordingly be set based on the average median absolute deviation value for the driver, i.e., an individual average deviation, such that the one or more thresholds are not exceeded by the driver's continued performance relative to the individual average deviation for the driver. In other words, if the driver continues to perform at its individual average deviation, e.g. at the 24^{th} percentile, then the driver is—relative to himself or herself—likely not deviating from the crowd wisdom sufficient to that a divergence indicator is necessary. In other words, although there is some deviation, the driver behavior is likely safe. In some embodiments, the driver's individual average deviation may be determined using multiple trips.

The characterization of the driver with respect to the one or more crowd wisdom based performance models permits the ready determination of an individualized standard, i.e., the individual average deviation, for the driver, as the individualized standard can be established with substantially less data via the comparison with the established crowd wisdom. Moreover, in some embodiments, the crowd wisdom can include historical statistics imported from preestablished databases and/or literature.

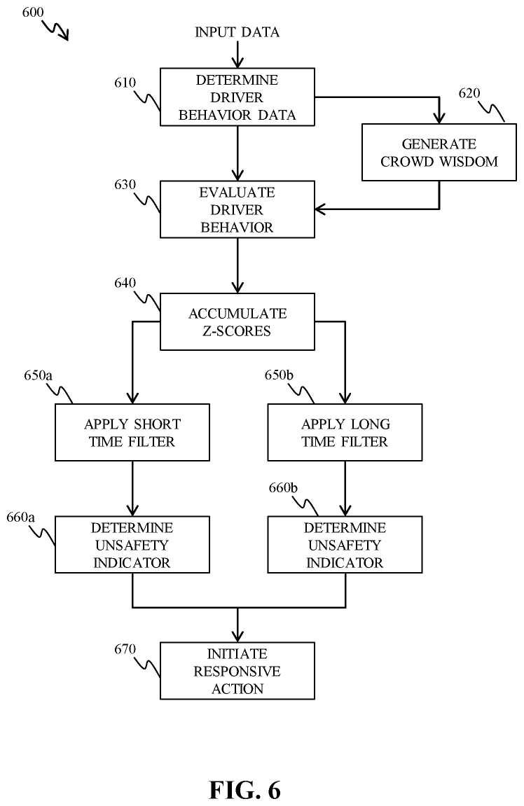

Turning now to FIG. 6, an exemplary method 600 for monitoring driver performance in accordance with at least one embodiment will now be discussed. The method will be described with reference to z-scores, solely for illustrative purposes, with the understanding that, more generally, median absolute deviations may be used.

At step 610, input data collected from the various devices 110 is processed to generate the driver performance related data. The driver performance data may be thereafter stored for transmission to the server system 200 and evaluated for deviation from the crowd wisdom.

At step 620, driver performance related data transmitted to the server system 200 is processed, along with driver performance related data from the plurality of vehicles across the system 10, by the server system to generate the one or more performance models reflecting desirable driver behaviors based on the crowd wisdom. As discussed above, each of the performance models corresponds to a statistical distribution characterizing historical driver behavior under given driving circumstances and across the plurality of vehicles of the system. Each performance model is defined by the central value and dispersion of the corresponding statistical distribution, such that the performance model reflects the crowd wisdom for the driver behavior under the driving circumstances.

At step 630, the driver performance related data is compared to the one or more performance models, so as to determine statistically significant deviations from the one or more performance models. As discussed above, the z-score is determined for the current driver behavior, with respect to the performance model reflecting the crowd wisdom based driver behavior under the same or similar driving circumstances.

At step 640, a running accumulation, or sum total, of calculated z-scores is maintained for each considered driver behavior. As discussed above, the time periods over which the z-scores are accumulated may be settable according to the driver behavior of interest, or to detect divergences over shorter or longer terms. An exponentially weighted moving average (IIR) filter may also be applied to more heavily favor more recent data over less recent data.

Such time filtering of the z-scores may occur at step 650a-b. As discussed above, a long-term accumulation of z-scores may be utilized to detect fatigue, whereas a short-term accumulation of z-scores may be utilized to detect distraction or otherwise more immediately impeded performance.

At step 660a-b, the driver behavior may be identified as undesired in response to the accumulated z-score value exceeding one or more deviation thresholds. As discussed above, such exceeding of the deviation thresholds may, for instance, occur as a result of a longer-term persistent divergence from the crowd wisdom and/or as a result of a short-term extreme divergence from the crowd wisdom. The divergence indicator may also be output in response to determining that the accumulated z-score value for the driver behavior exceeds one or more of the deviation thresholds. The divergence indicator can include information on type and severity of the driver behavior deviating from the crowd wisdom, which may be based on the specific behavior and the deviation thresholds exceeded.

At step 670, the one or more vehicle systems 140 may be controlled, based on the divergence indicator, to instruct the vehicle systems 140 to provide driver assistance warnings or notifications and/or to intervene in the operation of the vehicle to initiate corrective action. As discussed above, the type of warning or intervention may be based on the type and severity of the divergence indicator. The divergence indicator may also be transmitted back to the server system 200 for association with a driver profile, or stored in the memory for later retrieval.

Other related driver performance data may also be transmitted back to the server system 200 for association with the driver profile. The driver profile may therefore include data identifying the time-scale over which the performance deterioration (i.e., the driver behavior that diverges from the crowd wisdom) occurred. For example, the driver profile may indicate that the performance of the driver typically deteriorates (i.e., diverges from the crowd wisdom) gradually until about four hours of driving, after which the driver's performance deteriorates much more rapidly.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system for monitoring driver performance, comprising:
a server system configured to generate a performance model based on driver performance related data received from a plurality of vehicles, wherein the performance model mathematically characterizes crowd wisdom for a driving behavior under a set of driving circumstances; and
a respective on-vehicle system for each of the plurality of vehicles, configured to:
generate driver performance related data characterizing a performance of the driving behavior by a driver of the vehicle under the set of driving circumstances,
determine a deviation score between the generated driver performance related data and the performance model, for the driving behavior under the set of circumstances,
accumulate determined deviation scores for the driving behavior over a predetermined period of time to determine an accumulated deviation score,
generate divergence indicator in response to the accumulated deviation score exceeding one or more predetermined thresholds,
control one or more vehicle systems, based on the divergence indicator.

2. The system of claim 1, wherein the mathematical characterizations of the crowd wisdom include a central value and at least one dispersion, which characterize the crowd wisdom for the driving behavior under the set of driving circumstances.

3. The system of claim 2,
wherein the mathematical characterization of the crowd wisdom for the driving behavior is a statistical distribution reflecting the driving behavior performed by respective drivers of the plurality of vehicles, and
wherein the determination of the deviation score is based on the central value and the at least one dispersion of the statistical distribution.

4. The system of claim 3, wherein the statistical distribution is an asymmetrical distribution, and the at least one dispersion is a plurality of dispersions.

5. The system of claim 1, wherein the deviation score is a percentile.

6. The system of claim 1, wherein the predetermined period of time is a first period of time such that the accumulated deviation score exceeding the one or more predetermined thresholds indicates driver distraction or impeded performance.

7. The system of claim 1, wherein the predetermined period of time is a second period of time longer than first period of time such that the accumulated deviation score exceeding the one or more predetermined thresholds indicates driver fatigue.

8. The system of claim 1, wherein the on-board system is further configured to generate real-time or near real-time warnings in response to the divergence indicator.

9. The system of claim 1, wherein the on-board system is further configured to determine the deviation score both periodically and on-demand.

10. The system of claim 1, wherein the performance model comprises a plurality of performance sub-models that separate the driving behavior into constituent longitudinal, lateral, and/or timing driving behaviors.

11. A method for monitoring driver performance, comprising:
receive a performance model generated based on driver performance related data received from a plurality of vehicles, wherein the performance model mathematically characterizes crowd wisdom for a driving behavior under a set of driving circumstances;
generating driver performance related data characterizing a performance of the driving behavior by a driver of a vehicle of the plurality of vehicles under the set of driving circumstances;
determining a deviation score between the generated driver performance related data and the performance model, for the driving behavior under the set of circumstances;
accumulating determined deviation scores for the driving behavior over a predetermined period of time to determine an accumulated deviation score;
generating a divergence indicator in response to the accumulated deviation score exceeding one or more predetermined thresholds; and
controlling one or more vehicle systems of the vehicle, based on the divergence indicator.

12. The method of claim 11, wherein the mathematical characterizations of the crowd wisdom include a central value and at least one dispersion, which characterize crowd wisdom for the driving behavior under the set of driving circumstances.

13. The method of claim 12,
wherein the mathematical characterization of the crowd wisdom for the driving behavior is a statistical distribution reflecting the driving behavior performed by respective drivers of the plurality of vehicles, and
wherein the determination of the deviation score is based on the central value and the at least one dispersion of the statistical distribution.

14. The method of claim 13, wherein the statistical distribution is an asymmetrical distribution, and the at least one dispersion is a plurality of dispersions.

15. The method of claim 11, wherein the deviation score is a percentile.

16. The method of claim 11, wherein the predetermined period of time is a first period of time such that the accumulated deviation score exceeding the one or more predetermined thresholds indicates driver distraction or impeded performance.

17. The method of claim 11, wherein the predetermined period of time is a second period of time such that the accumulated deviation score exceeding the one or more predetermined thresholds indicates driver fatigue.

18. The method of claim 11, wherein generating the performance model is done by one or more neural networks trained with the driver performance related data received from the plurality of vehicles.

19. The method of claim 11, wherein the deviation score is determined both periodically and on-demand.

20. The method of claim 11, wherein the performance model comprises a plurality of performance sub-models that separate the driving behavior into constituent longitudinal, lateral, and/or timing driving behaviors.
